(19) United States
(12) Patent Application Publication
(10) Pub. No.: US 2026/0109145 A1
(43) Pub. Date: Apr. 23, 2026

(54) PRINTING APPARATUS

(71) Applicant: CANON KABUSHIKI KAISHA, Tokyo (JP)

(72) Inventor: HISAO OKITA, Kanagawa (JP)

(21) Appl. No.: 19/362,728

(22) Filed: Oct. 20, 2025

(30) Foreign Application Priority Data
Oct. 22, 2024 (JP) 2024-185943

(51) Int. Cl. B41J 2/045; B41J 2/14; B41J 2/21; B41J 11/00

(52) U.S. Cl. CPC B41J 2/04551; B41J 2/0452; B41J 2/0454; B41J 2/04543; B41J 2/04563; B41J 2/0457; B41J 2/0458; B41J 2/14016; B41J 2/2132; B41J 11/008; B41J 2002/14379

(57) ABSTRACT

A printing apparatus is provided that includes a print head having a nozzle array including a plurality of nozzles arranged in a first direction, and is configured to print an image on a print medium by ejecting ink while moving the print head in a second direction intersecting the first direction. The apparatus further includes a control unit for controlling the number of nozzles used for printing on the basis of a limit value of electric power that can be supplied from a power supply to the print head. The control unit can execute first control in which printing is performed using all of the nozzles of the nozzle array and second control in which printing is performed using some of the nozzles of the nozzle array. Under the second control, the control unit performs printing on an area obtained by reducing an area printable under the first control.

### BACKGROUND

### Field of the Technology

The present disclosure relates to a printing apparatus.

### Description of the Related Art

In an ink-jet type printing apparatus, a print head having a plurality of printing elements that include ink ejection ports and liquid channels in an integrated manner is used. Depending on the content of the image data to be printed, the density of printing dots exhibits a distribution among printing locations, and the electric power required to drive the head and the printing amount fluctuate in accordance with the printing dot density. To enable uniform printing at all times regardless of such fluctuations in required power, a large-capacity power supply and a circuit capable of withstanding the input and output of this large-capacity power supply have to be provided on the assumption that the printing dot density is high and the required power is large. As a result, the printing apparatus can be large and expensive.

Meanwhile, in ordinary printing in general, high-density printing, for example, at the maximum printing amount implementable by the head accounts for only a very small part of the whole printing, while low-density printing is performed for the most part of printing, hence the required power is not large. Therefore, various methods have been proposed to control the printing method in accordance with the number of printing dots within a certain range, thereby limiting the amount of electric power used per unit time and compensating printing quality even at high-density printing locations while maintaining high-speed printing for ordinary image data.

For example, a method is known in which image data for an area (scanning area) that can be printed by one scan using the print head is divided into a plurality of portions, and scanning is performed multiple times using the print head in the same scanning area (see Japanese Examined Patent Publication No. H06-47290). In the disclosure of Japanese Patent Application Publication No. 2005-224955, when the density of print data is high and the printing elements are driven exceeding the power-supply capacity during each scan, scanning is divided into multiple scanning operations, or the moving speed of the carriage is reduced. This allows the capacity of the power supply to be fully utilized while suppressing a decrease in throughput and reducing power supply costs.

### SUMMARY

The present disclosure is directed to provide a printing apparatus which can more efficiently utilize the capacity of a power supply.

The printing apparatus of the present disclosure includes:

a print head having a nozzle array including a plurality of nozzles arranged in a first direction, the printing apparatus being configured to print an image on a print medium by ejecting ink while moving the print head relative to the print medium in a second direction intersecting the first direction;

a power supply configured to supply electric power to the print head; and

a control unit for controlling the number of nozzles to be used for printing among the plurality of nozzles constituting the nozzle array, on the basis of an upper limit value of electric power that can be supplied by the power supply to the print head, wherein

the control unit can perform:

first control in which printing is performed using all of the nozzles of the nozzle array; and

second control in which printing is performed using some of the nozzles of the nozzle array, and wherein

under the second control, printing is performed on a partial area obtained by reducing a scanning area, which is an area printable under the first control, in the first direction.

Further features of the present disclosure will become apparent from the following description of embodiments with reference to the attached drawings. The following description of embodiments is described by way of example.

### BRIEF DESCRIPTION OF THE DRAWINGS

FIG. 1 is a view of a configuration around a print head of a printing apparatus according to an embodiment.

FIG. 2 is an internal block diagram of the printing apparatus according to the embodiment.

FIG. 3 is a diagram illustrating a method for counting dots by a dot count portion according to an embodiment.

FIG. 4 is a diagram illustrating a monitoring area in a print medium according to an embodiment.

FIG. 5 is a diagram of nozzle arrays of respective colors of a print head according to the embodiment.

FIG. 6 is a diagram illustrating the positional relationship of blocks corresponding to nozzle arrays of respective colors of a print head according to an embodiment.

FIG. 7 is a diagram illustrating a case where the width of a monitoring area in the Y direction is m dots according to an embodiment.

FIG. 8 is a diagram illustrating a case where the width of a monitoring area in the Y direction is m-n dots according to an embodiment.

FIG. 9 is a flowchart illustrating printing control according to an embodiment.

FIG. 10 is a diagram illustrating area division for performing temperature control according to an embodiment.

FIG. 11A is a diagram illustrating some of the nozzles of nozzle arrays in a setting for a printing area including a downstream end portion of a scanning area in the Y direction according to an embodiment.

FIG. 11B is a diagram illustrating an example in which, in a setting for a printing area including a downstream end portion of a scanning area in the Y direction according to an embodiment, the scanning area is set with a partial area and a non-printing area other than the partial area.

FIG. 12A is a diagram illustrating some of the nozzles of nozzle arrays in a setting for a printing area including an upstream end portion of a scanning area in the Y direction according to an embodiment.

FIG. 12B is a diagram illustrating an example in which, in a setting for a printing area including an upstream end portion of a scanning area in the Y direction according to an embodiment, the scanning area is set with a partial area and a non-printing area other than the partial area.

FIG. 13 is a view of a print head according to an embodiment.

### DESCRIPTION OF THE EMBODIMENTS

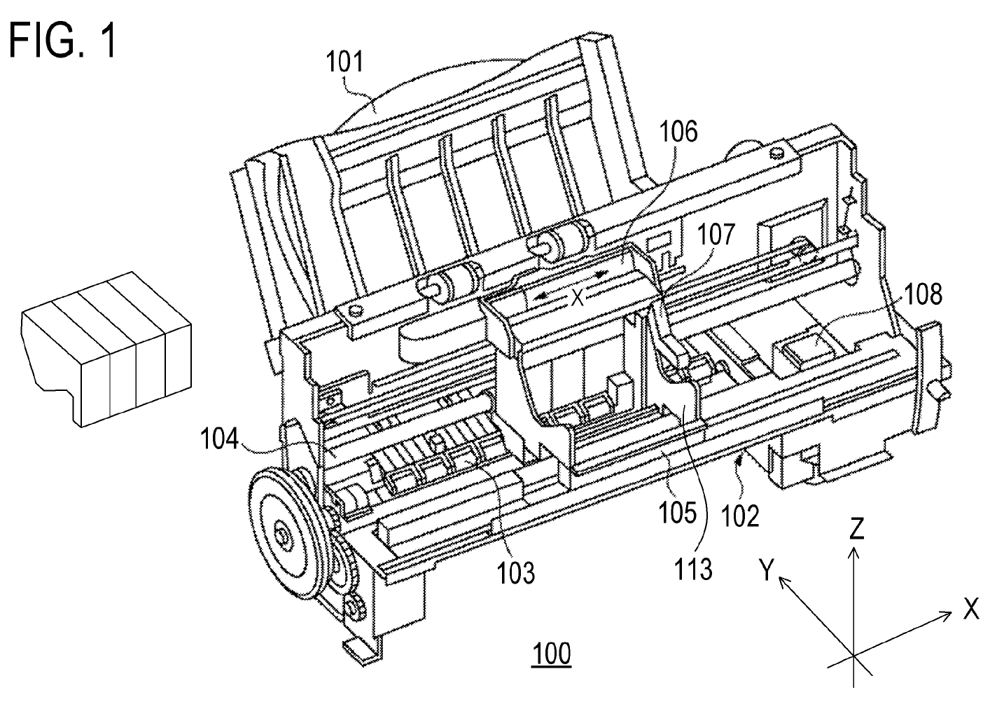

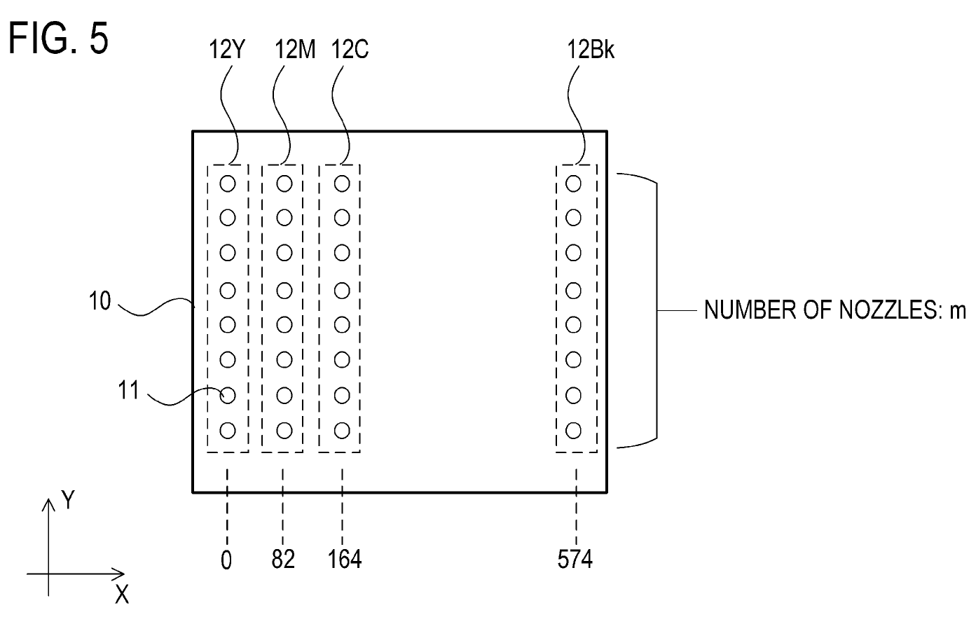

Hereinafter, embodiments of the present disclosure will be described in detail in conjunction with the accompanying drawings. Note that the following embodiments are not intended to limit the present disclosure, and not all the combinations of features described in the disclosure of the present embodiments are necessarily essential as means for solution of the present disclosure. The same elements are designated by the same reference numerals, and their description will not be repeated. In the following description, the direction in which the print head 10 moves relative to the print medium (main scanning direction or second direction) is the X direction, the direction in which the print medium is conveyed (sub-scanning direction or first direction) in the printing apparatus 100 is the Y direction, and the vertical direction is defined as the Z direction (see FIG. 1). The first direction (Y direction) is parallel to the direction in which the nozzles 11 are arranged in each of the plurality of nozzle arrays 12 provided in the print head 10 (see FIG. 5). The first and second directions cross each other (orthogonal in an embodiment).

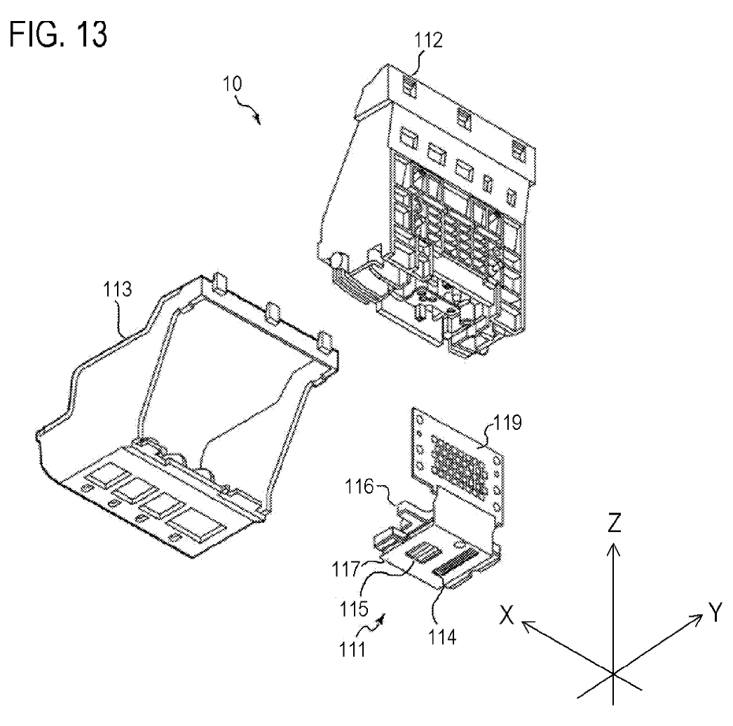

With reference to FIGS. 1 and 13, the ink-jet type printing apparatus 100 of an embodiment will be described. The printing apparatus 100 includes an automatic feeding portion 101, a conveying portion 103, and a recovery portion 108. The automatic feeding portion 101 automatically feeds a print medium such as paper into the apparatus body. The conveying portion 103 guides the print medium sent out one by one from the automatic feeding portion 101 to a prescribed printing position, and guides the print medium from the printing position to the discharge portion 102. The recovery portion 108 performs recovery processing to the printing portion which performs desired printing on the print medium conveyed to the printing position. The printing portion includes a carriage 105 supported movably in the main scanning direction (X direction) by a carriage shaft 104 and the print head 10 removably mounted on the carriage 105.

The carriage 105 is provided with a carriage cover 106 engaged with the carriage 105 to guide the print head 10 (see FIG. 13) to a prescribed mounting position on the carriage 105, and a head set lever 107. The head set lever 107 engages with the tank holder 113 of the print head 10 and presses the print head 10 to be set to a prescribed mounting position. A spring-biased head set plate (not shown) is provided on the upper part of the carriage 105 in a rotatable manner with respect to the head set lever shaft and at its engagement portion with the print head 10. The head set lever 107 is configured to mount the print head 10 to the carriage 105 by the spring force while pressing the print head 10.

The printing apparatus 100 prints an image on the print medium by ejecting ink while moving the print head 10 relative to the print medium in the second direction (X direction) that crosses the first direction (Y direction).

FIG. 13 is a view of a structure of the print head 10 of the embodiment. The print head 10 is a side-shooter type print head that ejects droplets in a substantially vertical direction with respect to the heater substrate. The print head 10 includes a printing element unit 111, an ink supply unit 112, and the tank holder 113. The printing element unit 111 includes a first printing element 114, a second printing element 115, a first plate 116, an electrical contact substrate 119, and a second plate 117.

The first plate 116, which influences the droplet ejection direction, requires planar accuracy, and is formed of alumina (Al₂O₃) material with a thickness of 0.5 mm to 10 mm. The second plate 117 is a single plate-shaped member having a thickness of 0.5 mm to 1 mm and is laminated and fixed to the first plate 116 with an adhesive. The first printing element 114 and the second printing element 115 are bonded and fixed to a surface of the first plate 116.

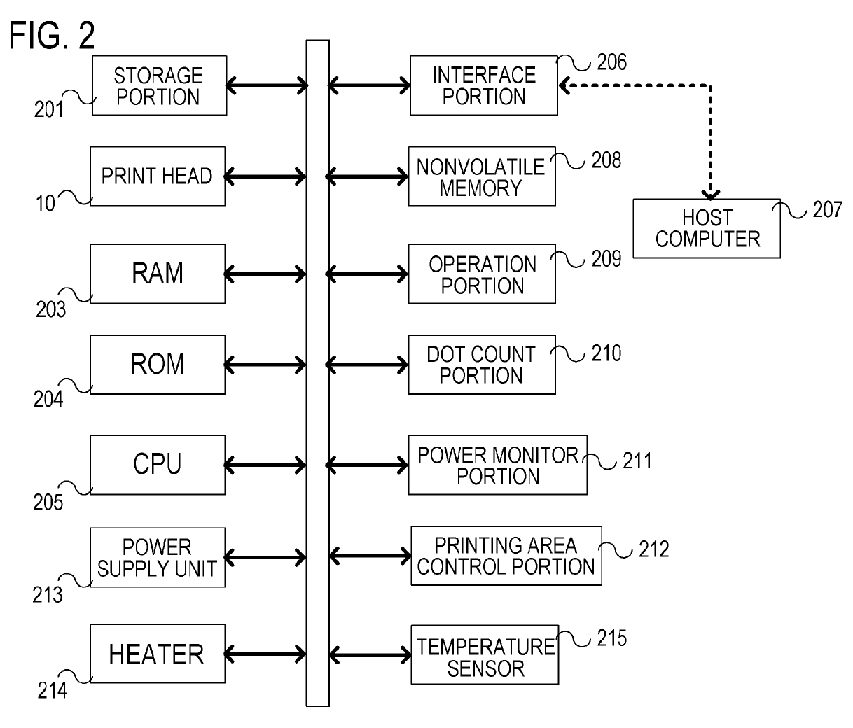

FIG. 2 is a block diagram of a configuration of the printing apparatus 100 of an embodiment.

A storage portion 201 stores electric power available for use in a single printing scan. The power available for use in a single printing scan is determined on the basis of the power capacity of a power supply unit 213 provided in the printing apparatus 100 and electric power used for purposes other than the printing scan.

The print head 10 has a function of printing an image on a print medium. Replaceable heads each have a unique ID, and whether the head has been replaced can be determined by comparing their IDs.

A RAM 203 (Random Access Memory) is a storage device that can retain information only while power is being supplied, and the retained information disappears once the power supply is cut off.

A ROM 204 (Read Only Memory) is a storage device that allows only data readout. The ROM 204 stores a control program for the printing apparatus 100. A CPU 205 reads out the control program from the ROM 204 and executes the program to control the operation of each unit.

The CPU 205 reads out the control program from the ROM 204 and controls the operation of each unit according to the control program.

An interface portion 206 functions to connect the printing apparatus 100 to a host computer 207, receive image data from the host computer 207, and transmit the status of the printing apparatus 100 to the host computer 207.

A nonvolatile memory 208 is a storage device that stores various types of information and can continue to retain the stored information even when the power supply is cut off.

An operation portion 209 includes operation members such as keys for receiving operations from a user and a display device for notifying the user of errors and the like.

A dot count portion 210 is a circuit that functions to calculate the number of dots printed in a printing scan by the print head 10 (i.e., the number of ink droplets ejected from the nozzles).

A power monitor portion 211 calculates the number of times the printing elements are driven in a printing scan by the print head 10. The number of times the printing elements are driven in a printing scan is a quantity related to the electric power used for the printing scan.

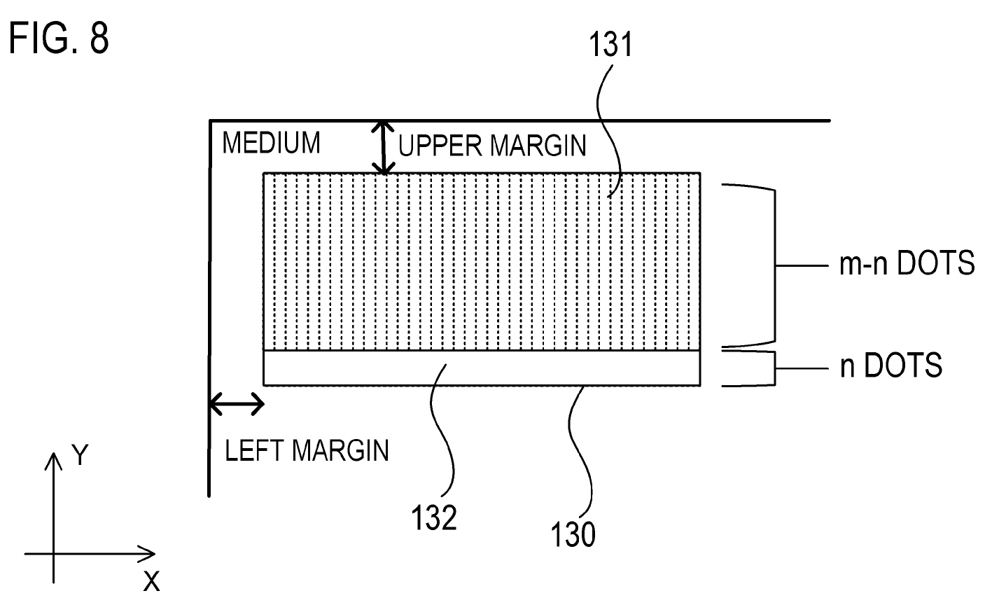

A printing area control portion 212 is a control unit for controlling the number of nozzles 11 used in a printing scan among the plurality of nozzles 11 constituting a nozzle array 12, on the basis of an upper limit value for electric power that the power supply unit 213 can supply to the print head 10. The printing area control portion 212 can perform first control in which printing is performed using all of the nozzles 11 of the nozzle array 12, and second control in which printing is performed using some of the nozzles 11 of the nozzle array 12 (see FIG. 5). Under the second control, printing is performed in a partial area 131 obtained by reducing, in the first direction (Y direction), a scanning area 130 printable by the print head 10, namely the maximum area printable in a single printing scan (see FIG. 8).

The printing area control portion 212 performs printing under the second control when the electric power required to perform printing under the first control exceeds the upper limit value. The printing area control portion 212 determines the width of the partial area 131 in the first direction (Y direction) so that the electric power required to perform printing under the second control is equal to or less than the upper limit value. The printing area control portion 212 determines the width of the partial area 131 in the first direction (Y direction) so that the width is maximized within a range in which the electric power required to perform printing under the second control does not exceed the upper limit value. Depending on the dot density of image data to be printed in a single printing scan, the width of the partial area 131 in the first direction (Y direction) in the second control is greater than 50% of the width of the scanning area 130 in the first direction (Y direction). As a result, the number of times the printing elements of the print head 10 are driven in a single printing scan can be reduced, and the electric power required for the single printing scan can be suppressed.

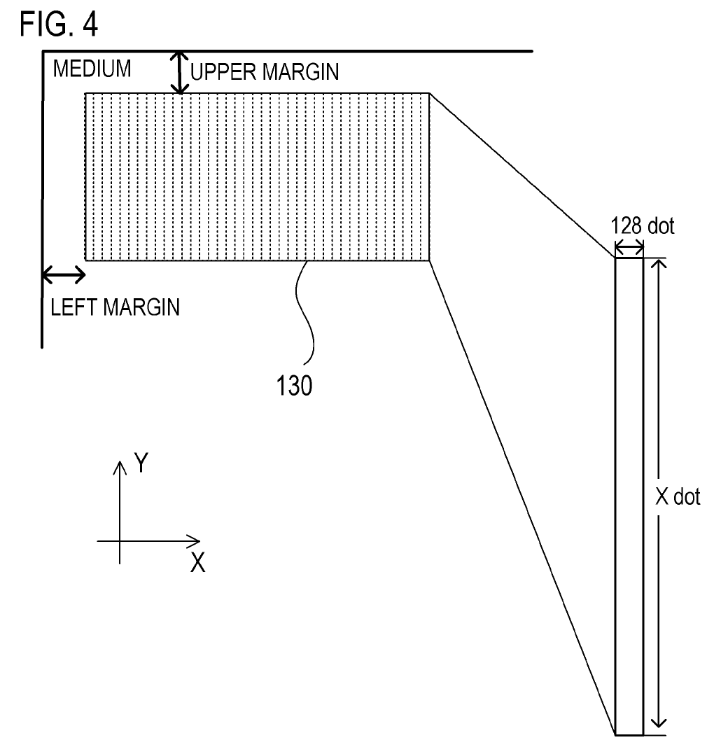

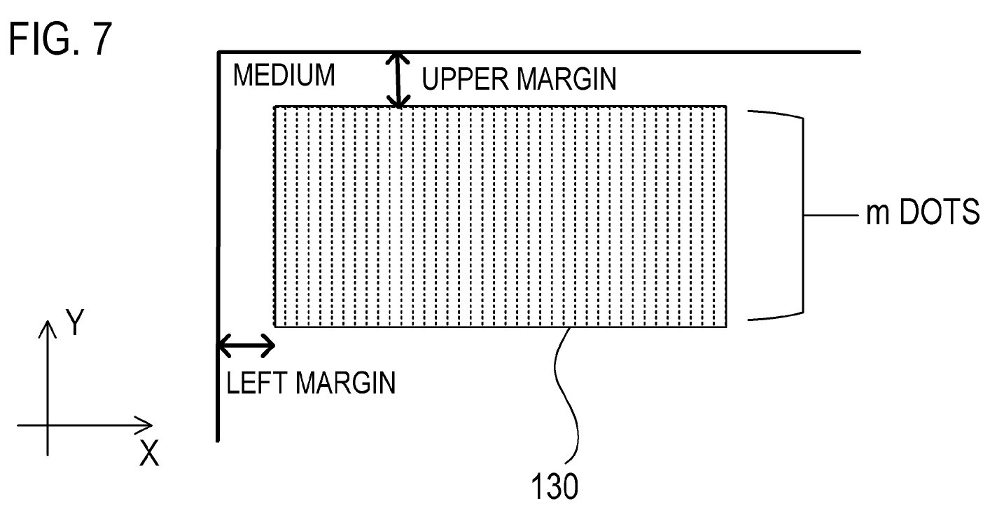

As shown in FIG. 4, the power monitor portion 211 divides the scanning area 130 into multiple sections in the second direction (X direction) and determines whether there is any section in which the electric power required to perform printing under the first control exceeds the upper limit value. When the electric power required to perform printing under the first control is equal to or less than the upper limit value in all of the sections, the printing area control portion 212 performs printing under the first control. In this case, as shown in FIG. 7, the entire scanning area 130 is a printing area in which printing scanning is performed in a single printing scan.

When the electric power required to perform printing under the first control exceeds the upper limit value in any of the sections, the printing area control portion 212 performs printing under the second control. In this case, as shown in FIG. 8, a partial area 131, which is obtained by reducing the scanning area 130 in the first direction (Y direction), is a printing area in which printing is performed in a single printing scan. The printing area control portion 212 divides the partial area 131 into multiple sections in the second direction (X direction) and determines the width of the partial area 131 in the first direction (Y direction) so that the electric power required to perform printing under the second control is equal to or less than the upper limit value in all of the plurality of sections. In FIG. 8, the partial area 131 has a width of m–n dots obtained by reducing the width of the scanning area 130 in the Y direction by n dots.

The power monitor portion 211 calculates the number of dots for which ink is ejected from the nozzles 11 for each section and determines that the electric power required to perform printing in the section exceeds the upper limit value when the calculated number of dots exceeds a threshold value.

The printing area control portion 212 performs a scan for printing printing data in the non-printing area 132 after a scan for printing on the partial area 131.

The power supply unit 213 supplies electric power to the print head 10, a heater 214, and other components of the printing apparatus 100.

The heater 214 is provided on a surface of the print head 10 on which the nozzles 11 are provided and heats an area around the nozzles 11.

The temperature sensor 215 is a detection unit for detecting the temperature of the surface of the print head 10 on which the nozzles 11 are provided.

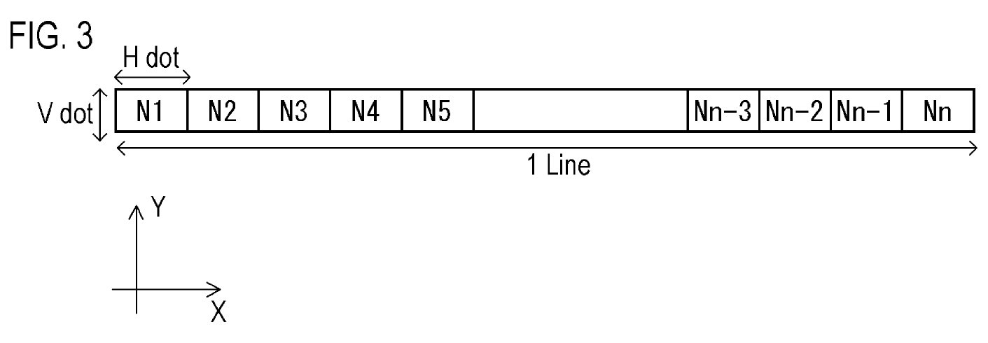

FIG. 3 is a schematic diagram illustrating how the dot count portion 210 calculates dot count values. The dot count portion 210 divides an image (one line) of a printing area to be printed in a single printing scan by the print head 10 into n sections (blocks) Ni (i = 1 to n) in the main scanning direction, each having V dots vertically x H dots horizontally. The dot count portion 210 calculates a dot count value (the number of nozzles to eject ink) for each section.

FIG. 4 is a schematic diagram illustrating, on the print medium, the scanning area 130 and the sections into which the scanning area 130 is divided for dot counting. The height X (dots) of the scanning area 130 is equal to the number of nozzles 11 (m dots) constituting the nozzle array 12 when the first control is performed, as shown in FIG. 7, and is smaller than the number of nozzles 11 (m dots) constituting the nozzle array 12 when the second control is performed, as shown in FIG. 8. The width D (dots) of each section is the same as a horizontal size H (dots) of the section in calculating the dot count value in FIG. 3, or N times that size (N = 1, 2, 3, …). In the example of FIG. 4, the width of one section in the X direction is 128 dots, but this value is only an example, and the width is not limited thereto.

FIG. 5 is a diagram illustrating the arrangement of nozzle arrays of the print head 10. The print head 10 has a plurality of nozzle arrays 12 arranged with a gap therebetween in the second direction (X direction). In an embodiment, the print head 10 has four nozzle arrays 12Y, 12M, 12C, and 12Bk. The gap in the X direction between the nozzle arrays 12Y and 12M and between the nozzle arrays 12M and 12C is 82 dots (600 dpi), and the gap in the X direction between the nozzle arrays 12C and 12Bk is 410 dots (600 dpi). The nozzle array 12Y consists of nozzles 11 that eject yellow (Y) ink, the nozzle array 12M consists of nozzles 11 that eject magenta (M) ink, the nozzle array 12C consists of nozzles 11 that eject cyan (C) ink, and the nozzle array 12Bk consists of nozzles 11 that eject black (Bk) ink. Each nozzle array 12 consists of a plurality (m in the embodiment) of nozzles 11 arranged in the first direction (Y direction).

As shown in FIG. 5, the print head 10 of the embodiment has the nozzle arrays 12Y, 12M, 12C, and 12Bk arranged with a gap therebetween in the second direction (X direction). In this case, the positions of dots printed by nozzle arrays capable of simultaneous ejection shift in the X direction according to the gaps between the nozzle arrays.

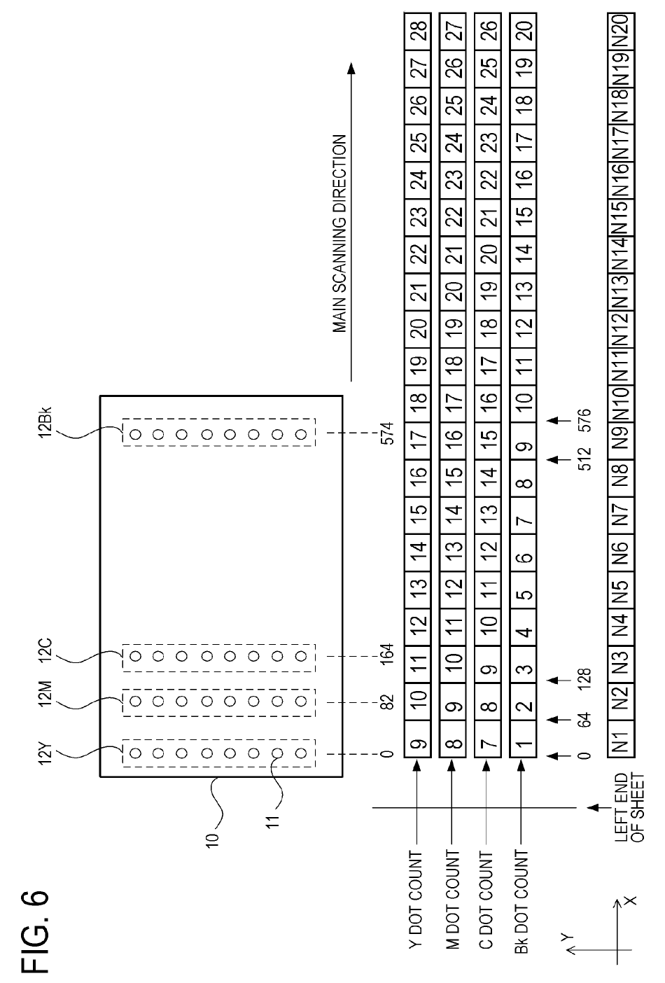

FIG. 6 illustrates the positional relationship between dots printed by the nozzles that are capable of simultaneous ejection in the print head 10. The print head 10 is configured to scan in the rightward direction in FIG. 6. FIG. 6 illustrates the relative relationship among colors when printing is actually performed at positions corresponding to stored dot count values for the colors. In FIG. 6, sections assigned the same numbers represent sections that are counted as dots for which ink is simultaneously ejected from nozzles. As shown in FIG. 3, the dot count values are calculated for each of the sections. Each color section in FIG. 6 represents a position of a section used to calculate a dot count value of the color.

The power monitor portion 211 divides the scanning area 130 into multiple sections (N1 to N20 in FIG. 6) in the second direction (X direction). The power monitor portion 211 determines whether, in a section in a position corresponding to each of the plurality of nozzle arrays 12, the total electric power required to perform printing in the section by the nozzles 11 of the corresponding nozzle array 12 under the first control exceeds the upper limit value when summed across the plurality of nozzle arrays 12, When the total is equal to or less than the upper limit value regardless of the position of the print head 10 in the second direction, the printing area control portion 212 performs printing under the first control. When the total exceeds the upper limit value while the print head 10 is at any position in the second direction, the printing area control portion 212 performs printing under the second control.

The power monitor portion 211 divides the partial area 131 into multiple sections (N1 to N20 in FIG. 6) in the second direction (X direction). The power monitor portion 211 determines whether, in a section in a position corresponding to each of the plurality of nozzle arrays 12, the total electric power required to perform printing in the section by the nozzles 11 of the corresponding nozzle array 12 under the second control, exceeds the upper limit value when summed across the plurality of nozzle arrays 12. The printing area control portion 212 determines the width of the partial area 131 in the first direction (Y direction) so that the above-described total is equal to or less than the upper limit value regardless of the position of the print head 10 in the second direction.

In an embodiment, the power monitor portion 211 calculates the total number of dots, for which ink is ejected from the nozzles 11 of the corresponding nozzle array 12, in a section at a position corresponding to each of the plurality of nozzle arrays 12 of the print head 10, summed across the plurality of nozzle arrays 12. When the total number exceeds a threshold value, the power monitor portion 211 determines that the total electric power across the plurality of nozzle arrays 12 required to perform printing in the section in the position corresponding to each of the plurality of nozzle arrays 12 exceeds the upper limit value.

For example, when the print head 10 is at the position shown in FIG. 6, the sections corresponding to the nozzle arrays 12Y, 12M, 12C, and 12Bk are the sections N1, N2, N3, and N9, respectively. The power monitor portion 211 determines whether the total of the number of Y dots in the section N1, the number of M dots in the section N2, the number of C dots in the section N3, and the number of Bk dots in the section N9 exceeds the threshold value. When the total exceeds the threshold value, the power monitor portion 211 determines, for the position of the print head 10 shown in FIG. 6, that the electric power required to perform printing under the first control exceeds the upper limit value. In this case, the power monitor portion 211 performs a similar calculation for the partial area 131 obtained by reducing the width of the scanning area 130 in the Y direction. The printing area control portion 212 determines the width of the partial area 131 in the Y direction so that the total number of dots in a section corresponding to each nozzle array is equal to or less than the threshold value.

FIG. 7 illustrates a printing area when printing under the first control, in which printing is performed using all of the nozzles 11 of the nozzle array 12, is performed. In this case, the scanning area 130 where an image can be printed under the first control and the printing area where printing is actually performed are the same. In the embodiment, since each nozzle array 12 has m nozzles 11, the width of the scanning area in the Y direction is m dots.

FIG. 8 illustrates a printing area when printing is performed under the second control, in which printing is performed using some of the nozzles 11 of the nozzle arrays 12. In this case, printing is performed in the partial area 131 obtained by reducing the scanning area 130 in the Y direction. The area other than the partial area 131 in the scanning area 130 is a non-printing area 132 in which no printing is performed. FIG. 8 illustrates the case in which n nozzles 11 out of m nozzles 11 of the nozzle arrays 12 do not perform printing. In this case, the partial area 131 is obtained by reducing the scanning area 130 by n dots in the Y direction, and the width of the partial area 131 in the Y direction is m-n dots.

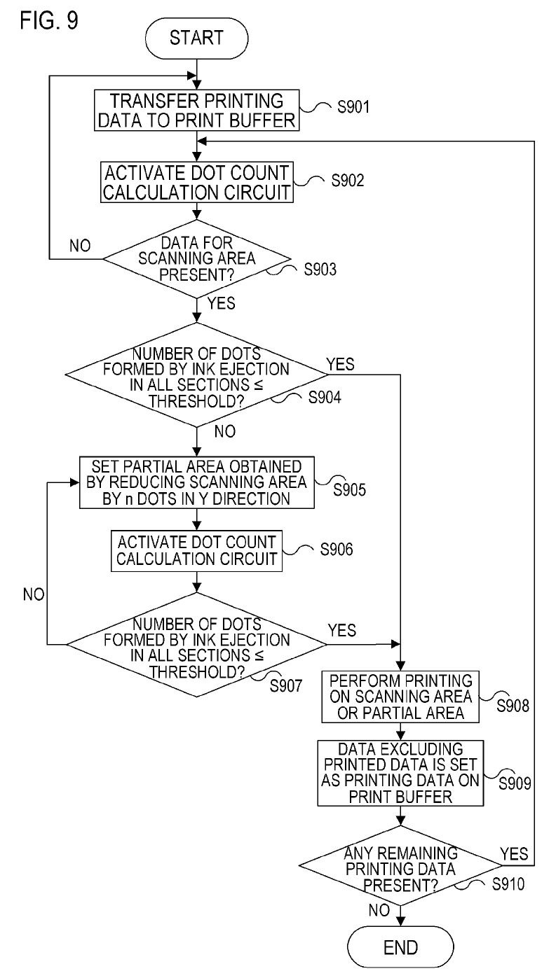

FIG. 9 is a flowchart for illustrating the printing control carried out by the printing apparatus 100 of the embodiment. This flowchart shows printing control for an image in one scanning area by the print head 10. The processing according to the flowchart is executed by the CPU 205.

In step S901, the CPU 205 transfers printing data to the RAM 203 that functions as a print buffer. The CPU 205 converts image data input from the host computer 207 through the interface portion 206 into the printing data which can be used for printing by the print head 10. The CPU 205 transfers the printing data corresponding to the image data in the scanning area in the current printing scan to the print buffer.

In step S902, the CPU 205 activates the dot count portion 210 to calculate the dot count values of the transferred printing data.

In step S903, the CPU 205 determines whether the printing data for the entire scanning area exists and repeats the processing of steps S901 and S902 until the printing data for the entire scanning area is transferred to the print buffer. If it is determined in step S903 that the printing data for the entire scanning area exists, the CPU 205 executes step S904.

In step S904, the CPU 205 divides the scanning area 130 into multiple sections in the X direction and determines whether the electric power required to perform printing under the first control is equal to or less than the upper limit value in all the sections. Here, the CPU 205 calculates, for each section, the number of dots, for which ink is ejected from the nozzles 11 and determines whether the calculated dot number is equal to or smaller than a threshold value for all the sections. Note that the manner of calculating the number of dots when the print head 10 has a plurality of nozzle arrays 12 has already been described with reference to FIG. 6, and will not be described in detail here. If the determination in step S904 is true, the CPU 205 executes step S908. If there is a section in which the number of dots to be ejected exceeds the threshold value, the CPU 205 interrupts the determination processing midway and executes step S905.

In step S905, the CPU 205 sets a partial area reduced by n dots in the Y direction as shown in FIG. 8.

In steps S906 and S907, the CPU 205 divides the partial area 131 set in step S905 into multiple sections in the X direction and determines whether the electric power required to perform printing under the second control is equal to or less than the upper limit value for all of the sections. Here, the CPU 205 calculates, for each section, the number of dots for which ink is ejected from the nozzles 11 and determines whether the calculated number of dots is equal to or less than the threshold value for all of the sections. Note that the manner of calculating the number of dots when the print head 10 has a plurality of nozzle arrays 12 has already been described with reference to FIG. 6 and will not be described in detail here. If the determination in step S907 is true, the CPU 205 executes step S908. If there is a section in which the number of dots for which ink is ejected exceeds the threshold value, the CPU 205 interrupts the determination processing midway and executes step S905.

In step S908, the CPU 205 performs printing on the scanning area under the first control if the result of determination in step S904 is true and performs printing on the partial area under the second control if the result of determination in step S907 is true.

In step S909, the CPU 205 newly defines, as the printing data on the print buffer, the data obtained by excluding the printing data already printed in step S908 from the printing data corresponding to the scanning area that has been transferred to the print buffer in steps S901 to S903.

In step S910, the CPU 205 determines whether there is any unprinted data among the printing data transferred to the print buffer in steps S901 to S903 and repeats the above processing until no unprinted data remains.

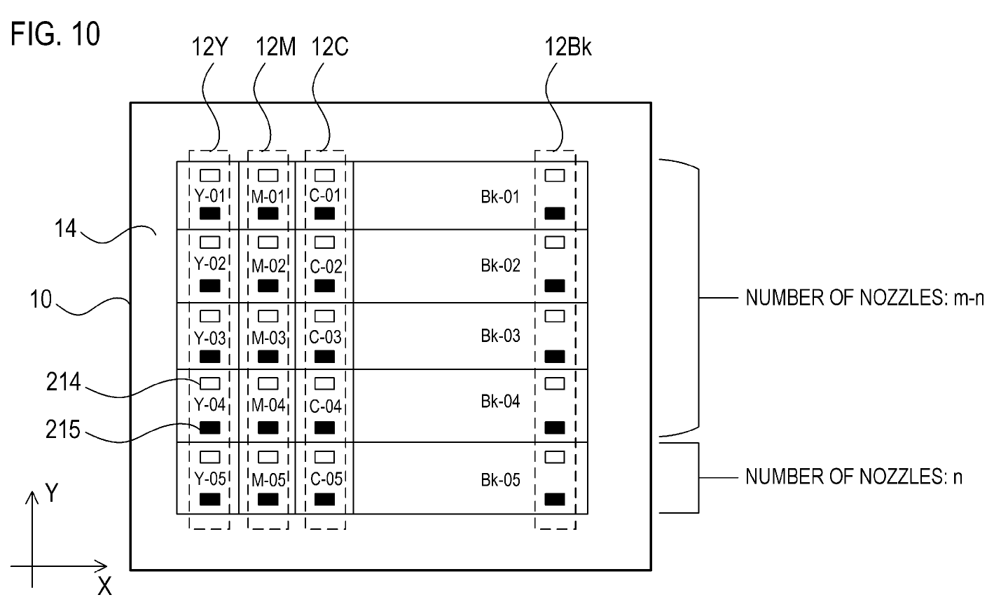

FIG. 10 illustrates a configuration for temperature control of the print head 10. The nozzle surface 14, on which the nozzles 11 of the print head 10 are provided, is divided into a plurality of areas, and a heater 214 and a temperature sensor 215 are provided in each area. That is, the print head 10 has a plurality of heaters 214 and a plurality of temperature sensors 215. The temperature sensor 215 detects the temperature of each area. Each area includes one or more nozzles 11. The nozzle surface 14 is divided into areas Y-01 to Y-05 including yellow nozzles, areas M-01 to M-05 including magenta nozzles, areas C-01 to C-05 including cyan nozzles, and areas Bk-01 to Bk-05 including black nozzles. For the sake of avoiding complexity in the drawing, the nozzles 11 are not shown.

The CPU 205 performs temperature control to maintain the temperature around the nozzles 11 at a prescribed target temperature in order to achieve stable ejection. For the temperature control, the heater 214 is used to generate heat, and thus electric power for the heater 214 is required. The electric power for the heater 214 is power required for operations other than printing. The CPU 205 serves as a temperature control unit for controlling the heater 214 on the basis of a temperature detected by the temperature sensor 215 for each area. In this way, the CPU 205 can perform temperature control in a finely controlled manner.

In the printing control of FIG. 9, when performing the first control in which printing is performed using all of the nozzles 11 of the nozzle arrays 12, the CPU 205 performs third control in which the heaters 214 are controlled so that all of the plurality of areas reach a target temperature.

By the printing control of FIG. 9, printing may be performed on the partial area smaller than the scanning area. That is, the CPU 205 performs the second control in which printing is performed using some of the nozzles 11 of the nozzle arrays 12. In the example shown in FIG. 10, a first area including the nozzles 11 used for printing corresponds to Y-01 to Bk-04, and a second area including the nozzles 11 not used for printing corresponds to Y-05 to Bk-05. The first area corresponds to a printing area in the scanning area, while the second area corresponds to an area other than the printing area (a non-printing area) in the scanning area.

During printing under the second control, the CPU 205 performs fourth control in which the heaters 214 of the second area are turned off, or the heaters 214 of the second area are controlled with a target temperature lower than the target temperature of the first area. In this way, the power for maintaining temperature can be reduced. By using the power saved from maintaining temperature as power available for printing, the printing area can be expanded. That is, the CPU 205 performs the printing control of FIG. 9 while increasing the upper limit value for the electric power that can be supplied to the print head 10 by the power supply unit 213 by an amount corresponding to the difference between the electric power required to perform the third control and the electric power required to perform the fourth control as the temperature control.

For example, when the temperature control area corresponding to the printing area includes the areas Y-01 to Bk-04 of FIG. 10, temperature control is performed so that the heaters 214 are not turned on in the temperature control areas Y-05 to Bk-05. In this way, the electric power that would otherwise be required for the heaters 214 to turn on in the temperature control areas Y-05 to Bk-05 can be saved and used as power for printing, so that the width of the printing area can be increased.

Although the heater 214 is turned on in the second area including the nozzles 11 which do not perform printing, temperature control may be performed so that its target temperature is lower than the target temperature of the heater 214 in the first area including the nozzles 11 which perform printing.

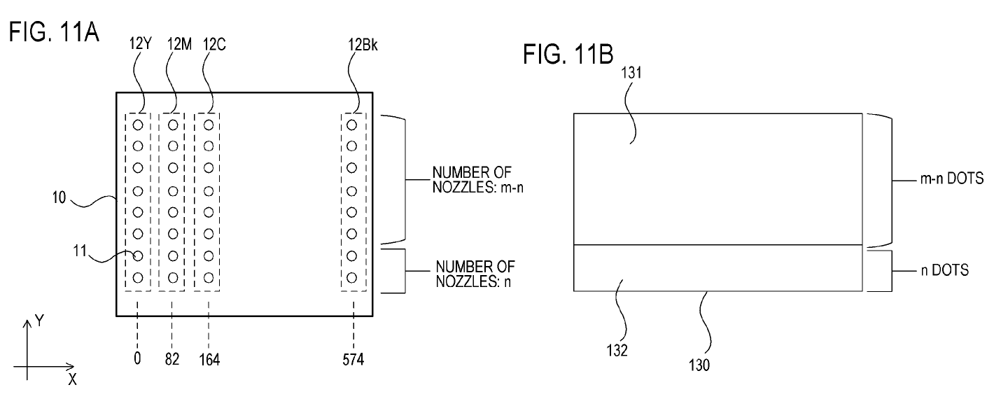

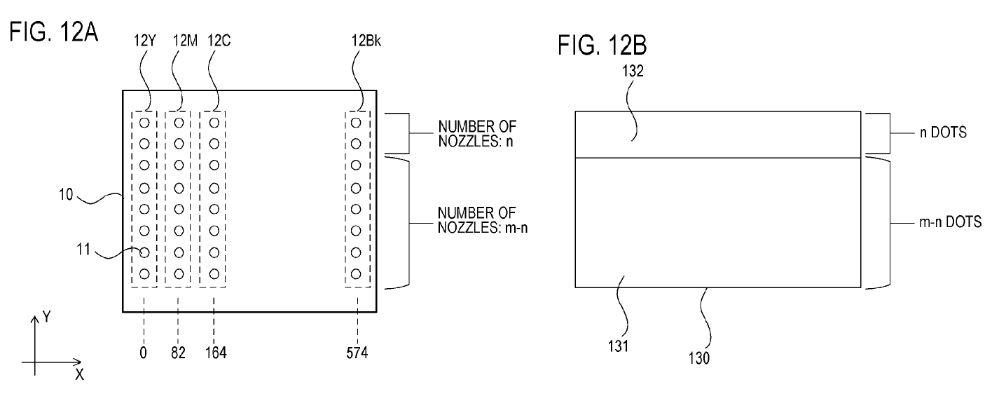

Further, when the number of ejections by one nozzle 11 exceeds a threshold, the nozzle 11 may fail (i.e., the end of the lifetime of the nozzle 11). Therefore, under the second control in which printing is performed using some of the nozzles 11 of the nozzle arrays 12, it may be possible to select between a first setting, in which the partial area is set to include an upstream end portion of the scanning area in the Y direction, and a second setting, in which the partial area is set to include a downstream end portion of the scanning area in the Y direction. FIG. 11B illustrates an example in which in the scanning area 130, the second setting defines the partial area 131 and the non-printing area 132 other than the partial area 131. FIG. 12B illustrates an example in which in the scanning area 130, the first setting defines the partial area 131 and the non-printing area 132 other than the partial area 131.

In a method for selecting between the first setting and the second setting in consideration of the lifetime of the nozzles 11, for example, the cumulative ejection count for each of the plurality of nozzles 11 is stored in a nonvolatile memory 208 that serves as a storage unit. The CPU 205 may select, from the first setting and the second setting, the setting in which the total ejection count of the nozzles 11 included in the non-printing area 132 other than the partial area is greater. Alternatively, the CPU 205 may select, from the first setting and the second setting, the setting in which the maximum ejection count of the nozzles 11 included in the non-printing area 132 other than the partial area 131 is greater. As a result, the non-printing area 132 includes the nozzles 11 having a larger ejection count, so that the lifetime of the print head 10 can be extended.

### Other Embodiments

The present disclosure can also be implemented by supplying, via a network or a storage medium, a program for realizing at least one of the functions of the above embodiments to a system or apparatus, and causing one or more processors in a computer of the system or apparatus to read and execute the program. Alternatively, the present disclosure can also be implemented by a circuit (e.g., an ASIC) that realizes at least one of the functions.

According to the present disclosure, it is possible to provide a printing apparatus capable of using power supply capacity more efficiently.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-185943, filed on October 22, 2024, which is hereby incorporated by reference herein in its entirety.

What is claimed is:

1. A printing apparatus comprising:
a print head having a nozzle array including a plurality of nozzles arranged in a first direction, the printing apparatus being configured to print an image on a print medium by ejecting ink while moving the print head relative to the print medium in a second direction intersecting the first direction;
a power supply configured to supply electric power to the print head; and
a control unit for controlling the number of nozzles to be used for printing among the plurality of nozzles constituting the nozzle array, on the basis of an upper limit value of electric power that can be supplied by the power supply to the print head, wherein
the control unit can perform:
first control in which printing is performed using all of the nozzles of the nozzle array; and
second control in which printing is performed using some of the nozzles of the nozzle array, and wherein
under the second control, printing is performed on a partial area obtained by reducing a scanning area, which is an area printable under the first control, in the first direction.

2. The printing apparatus according to claim 1, wherein
the control unit performs printing under the second control in a case where electric power required to perform printing under the first control exceeds the upper limit value.

3. The printing apparatus according to claim 1, wherein
the control unit determines a width of the partial area in the first direction so that electric power required to perform printing under the second control is not more than the upper limit value.

4. The printing apparatus according to claim 1, wherein
the control unit determines a width of the partial area in the first direction so that the width is maximized within a range in which electric power required to perform printing under the second control does not exceed the upper limit value.

5. The printing apparatus according to claim 1, wherein
under the second control, a width of the partial area in the first direction is larger than 50% of that of the scanning area in the first direction.

6. The printing apparatus according to claim 1, wherein
the control unit divides the scanning area into multiple sections in the second direction, and in a case where electric power required to perform printing under the first control exceeds the upper limit value in any of the sections, the control unit performs printing under the second control.

7. The printing apparatus according to claim 1, wherein
the control unit divides the partial area into multiple sections in the second direction and determines a width of the partial area in the first direction so that electric power required to perform printing under the second control is not more than the upper limit value in all of the multiple sections.

8. The printing apparatus according to claim 6, wherein
the control unit calculates the number of dots for which ink is ejected from the nozzles for each of the sections and determines electric power required to perform printing in the section exceeds the upper limit value in a case where the calculated number of dots exceeds a threshold value.

9. The printing apparatus according to claim 1, wherein
the print head includes a plurality of nozzle arrays provided with a gap therebetween in the second direction, and
wherein the control unit divides the scanning area into multiple sections in the second direction and performs printing under the second control in a case where, in the section located at a position corresponding to each of the plurality of nozzle arrays while the print head is at any position in the second direction, a total electric power across the plurality of nozzle arrays required to perform printing by the nozzles of the nozzle array corresponding to the section under the first control exceeds the upper limit value.

10. The printing apparatus according to claim 1,
wherein the print head comprises a plurality of nozzle arrays provided with a gap therebetween in the second direction, and
wherein the control unit divides the partial area into multiple sections in the second direction and determines a width of the partial area in the first direction so that, in the section located at a position corresponding to each of the plurality of nozzle arrays while the print head is at any position in the second direction, a total electric power across the plurality of nozzle arrays required to perform printing by the nozzles of the nozzle array corresponding to the section under the second control is not more than the upper limit value.

11. The printing apparatus according to claim 9, wherein
in a case where the total number of dots for which ink is ejected from the nozzles of the nozzle array corresponding to the section located at a position corresponding to each of the plurality of nozzle arrays of the print head across the plurality of nozzle arrays exceeds a threshold value, the control unit determines that a total electric power across the plurality of nozzle arrays required to perform printing in the section located at a position corresponding to each of the plurality of nozzle arrays exceeds the upper limit value.

12. The printing apparatus according to claim 1, further comprising:
a plurality of heaters respectively provided in a plurality of areas obtained by dividing a surface of the print head on which the nozzles are provided;
a detection unit for detecting a temperature in each of the plurality of areas; and
a temperature control unit for controlling the heater on the basis of the temperature detected by the detection unit,
wherein the temperature control unit performs:
third control in which the heaters are controlled such that all of the plurality of areas reach a target temperature in a case where the control unit performs the first control; and
fourth control in which the heaters are controlled such that, in a case where the control unit performs the second control, the heaters in a second area are turned off or a target temperature in the second area is set lower than a target temperature in a first area, with the first area being an area including the nozzles used for printing, and with the second area being an area including the nozzles not used for printing, and
wherein the control unit increases the upper limit value by a difference between electric power required to perform the third control and electric power required to perform the fourth control.

13. The printing apparatus according to claim 1, further comprising:
a storage unit for storing a cumulative ejection count for each of the plurality of nozzles,
wherein the control unit is capable of selecting between a first setting and a second setting under the second control, the partial area is set to an area that includes an upstream end portion of the scanning area in the first direction in the first setting, and the partial area is set to an area that includes a downstream end portion of the scanning area in the first direction in the second setting, and
wherein the control unit selects, from among the first setting and the second setting, the setting in which a total cumulative ejection count of the nozzles included in an area other than the partial area is greater.

14. The printing apparatus according to claim 1, further comprising:
a storage unit for storing a cumulative ejection count for each of the plurality of nozzles,
wherein the control unit is capable of selecting between a first setting and a second setting under the second control, the partial area is set to an area that includes an upstream end portion of the scanning area in the first direction in the first setting, and the partial area is set to an area that includes a downstream end portion of the scanning area in the first direction in the second setting, and
wherein the control unit selects, from among the first setting and the second setting, the setting in which a maximum cumulative ejection count of the nozzles included in the area other than the partial area is greater.
